(19) United States
(12) Patent Application Publication
(10) Pub. No.: US 2011/0192064 A1
(43) Pub. Date: Aug. 11, 2011

(54) Sign with interchangeable magnetic display.

(76) Inventor: John Bowman, St. John, IN (US)

(21) Appl. No.: 13/013,644

(22) Filed: Jan. 25, 2011

Related U.S. Application Data
(60) Provisional application No. 61/301,922, filed on Feb. 5, 2010.

(51) Int. Cl. G09F 7/04; G09F 7/00; G09F 15/00

(52) U.S. Cl. 40/600; 40/584; 40/607.14

(57) ABSTRACT

A sign with an interchangeable magnetic display. The sign comprising at least one panel, a display, a base, and a brace which limits relative motion between the panel and base. The panels form a ferromagnetic support surface which is attracted to a mounting surface of the display that is magnetic, the display thereby being easily attachable and detachable from the support surface. The base having a clamp used to attach the panels to business equipment, such as an exterior menu stand in a restaurant's traffic corridor, without damage to the stand.

### CROSS-REFERENCE TO RELATED APPLICATIONS

This application claims the benefit of U.S. Provisional Application No. 61/301,922, filed Feb. 5, 2010.

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISC APPENDIX

Not applicable.

### BACKGROUND OF THE INVENTION

(1) Field of the Invention

This invention relates generally to exhibiting signs. More particularly, the invention relates to signs whereby the letters, numbers, and other representations exhibited can be changed.

(2) Description of Related Art Including Information Disclosed Under 37 CFR 1.97 and 37 CFR 1.98.

In the industry related to the invention, it is desirable to provide a sign with at least one panel, preferably a semi-rigid panel, that receives a display and that can withstand forces of many kinds, such as that which occurs from pressing or pulling, and also that which occurs from exposure to the elements, such as the wind. By display it is meant, in addition to the common understanding of the words, a body that receives markings by any means, such as printed ink, intended to be viewed by passers-by and often displaying messages of interest, such as marketing advertisements for instance.

Such rigidity is accomplished in the prior art by several methods. For instance, by the use of a frame to which display panels are attached, as disclosed and claimed in U.S. Pat. No. 3,374,566 (Snediker). Or by the use of adjustable support arms to provide opposing support to display panels, as disclosed and claimed in U.S. Pat. No. 7,107,713 (Simson). However, these methods do not provide enough direct support for display panels, instead, providing direct support only to a small percentage of a display panel's surface area.

In the industry related to the invention, it is desirable to quickly and easily change the display panel of a sign. This is particularly important if the sign is outside and subject to harsh weather where the person changing the display panel is necessarily rushed to make the change. Or where the person changing the display panel is not mechanically inclined and finds it difficult to manipulate various hardware, such as screws or nuts and bolts.

The Snediker patent attempts to solve this problem but is problematic because it discloses display panels with letters and numbers printed directly thereon which hinders changing the representations quickly. U.S. Pat. No. 4,583,311 (Hosey) attempts to solve this problem with a changeable loop form of sign; however, it includes a large amount of hardware that must be removed and replaced for the display panel change to be accomplished. The Simson patent also attempts to address the problem with a support bracket that grabs a display panel and releases it when necessary, again using extensive hardware along with the display panels in order to make a change.

In the industry related to the invention, it is desirable to have a sign that does not damage existing business equipment, such as an existing outdoor menu to which the sign may be attached. Many prior art signs are attached to existing business equipment, such as outdoor menus found at restaurants, by the use of sheet metal screws, nuts and bolts, or similar attaching hardware. Attaching in this way invariably pierces the existing business equipment, which is often hollow and contains sensitive items within, such as electrical lighting. Piercing in this manner may also cause rain to enter the existing business equipment. Prior art signs that pierce existing business equipment can void a warranty on the existing business equipment.

From the foregoing, it can be seen that there exists within the industry related to this invention a desire to have a sign that can provide support against great forces, receives a display panel that is easily and quickly interchangeable, and does not damage existing business equipment, such as that existing business equipment to which the sign may be attached.

### BRIEF SUMMARY OF THE INVENTION

In an embodiment of the invention, a sign is provided that is capable of withstanding great force, such as strong winds for example, and can receive and support a display, for example by providing direct support to a large surface area of the display.

In an embodiment of the invention, a sign is provided that provides interchangeability of a display, that is easily and quickly performed, for example by providing a magnetic banner display that is attracted to and can be easily rolled onto a sheet metal face of the sign, without the use of any further attaching hardware. In an embodiment of the invention, a sign is provided that provides a display upon which many differently shaped markings, such as advertisements depicting a soda, hamburger, and fries, can be placed without necessitating a change in the shape of the display itself.

In an embodiment of the invention, a sign is provided that provides for plurality panel construction which decreases the cost of delivering the invention to its destination as compared to a same sized single panel construction.

In an embodiment of the invention, a sign is provided that is attachable to existing business equipment, such as outdoor menus for instance, by a non-piercing method, for example by clamping the sign to the existing business equipment.

In some embodiments of the invention, a sign is provided having at least one panel that is preferably made from a material such as sheet metal. The sign accepts a display with markings, such as printed advertisements for a drive thru restaurant's promotional menu items. The sign attaches to existing business equipment, such as an outdoor menu found in a traffic corridor of fast-food restaurants, without piercing the existing business equipment's shell. It also protects the display from wind, and provides for quickly and easily changing the display, for example by way of magnetic attachment of the display panel which requires no additional attaching hardware.

In an embodiment of the invention, the panel can comprise a planar support surface. Alternatively, the support surface may be non-planar. The panel may include a plurality of panels, and the panels of the plurality may include planar support surfaces, non-planar support surfaces, and combinations thereof. The plurality of panels can be configured to present a continuous combined support surface and can be configured to present an interrupted combined support surface.

In some embodiments, the display can have a magnetic mounting surface comprising a magnet material; that is, a material that produces a magnetic field. Further, in some embodiments, the majority of the mounting surface can comprise the magnet material, so that the magnetic mounting surface produces a substantially continuous magnetic field throughout the mounting surface. The magnetic mounting surface can connect securely to the support surface by bonding magnetically across the majority of the support surface.

The mounting surface can be planar and can be non-planar. The mounting surface can be semi-rigid and can be shaped to conform to the panel. Some embodiments, including embodiments with magnetic mounting surface, may comprise a mounting surface that is flexible. The flexible mounting surface can conform to one or more support surfaces having various shapes, including planar and non-planar, and the same flexible mounting surface can be attached to both planar and non-planar support surfaces without requiring modification to the flexible mounting surface. In particular, a flexible magnetic mounting surface can conform to a variously-shaped support surface and can bridge gaps and other inconsistencies occurring in the shape of the support surface and in areas where more than one support surface intersect. A flexible magnetic mounting surface can conform to shapes such that the magnetic connection between the mounting surface and the support surface is improved by close proximity between the mounting surface and the support surface.

The display can be shaped to match the support surface. Alternatively, the display can be shaped to diverge from the support surface in useful ways. For example, a support surface can be shaped as a simple rectangular surface, to facilitate ease of manufacturing. The rectangular support surface can provide support for a variety of differently-shaped displays, such as displays shaped to replicate a company logo or trademark, shaped to project a desired figure, as well as displays in the shape of readable text. Similar utility can be obtained with support surfaces of various shapes. Similarly, the display can be shaped to include cut-outs for the purpose of exposing portions of an underlying support surface. The display can be configured to conform to the support surface in some regions and to diverge from the support surface in other regions. At least the above-mentioned display and support surface characteristics enable various displays to be easily and quickly connected to various support surfaces. In use, displays can be attached and detached frequently to facilitate changing advertising efforts and time-dependent announcements, as well as other varying features and combinations.

These and other objects, features, benefits and advantages of the present invention will become apparent when taken together with this specification and its claims, and the attached drawings.

### BRIEF DESCRIPTION OF THE SEVERAL VIEWS OF THE DRAWING

FIG. 1 shows diagrammatically a sign according to the present invention as viewed from the front and attached to an outdoor menu.

FIG. 2 shows diagrammatically a sign according to the present invention as viewed from the rear and attached to an outdoor menu.

### DETAILED DESCRIPTION OF THE INVENTION

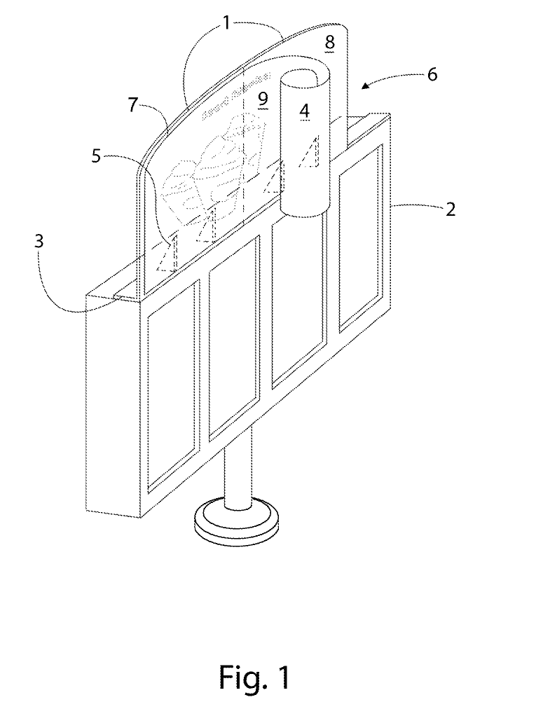

Referring to the drawings, particularly to FIG. 1, there is illustrated a sign for allowing easy changes of display advertisements embodying a preferred form of the invention designated generally as 6. There are two panels 1 that are positioned side-by-side. The panels 1 form a support surface 8 upon which is attached a magnetic banner 7 with an image surface 9 and a mounting surface 4 that attracts the support surface 8 of the panels 1. One of the panels 1 is attached at an angle to a base 3. The base 3 is attached to the menu stand 2. A brace 5 is attached to the base 3 and a panel 1 thereby limiting relative motion between the panel 1 and the base 3.

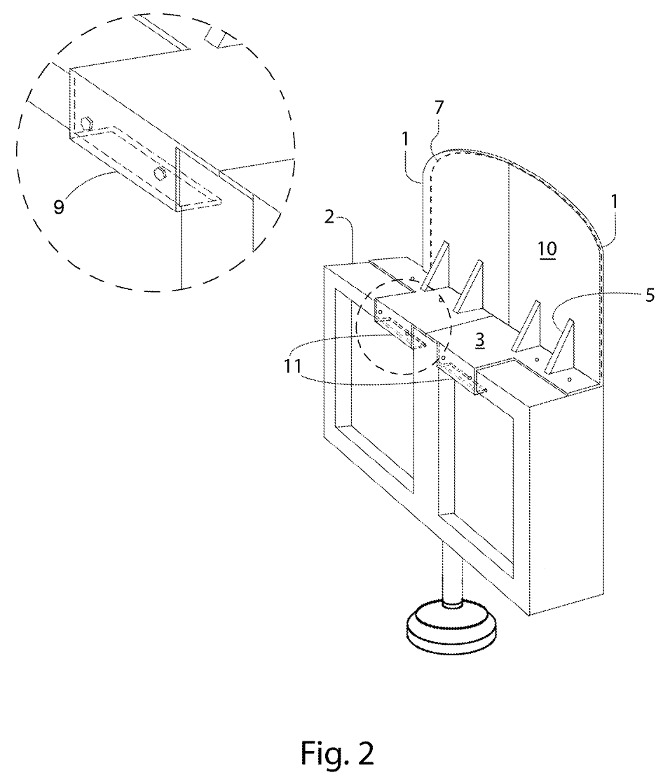

In FIG. 2 there is illustrated the present invention 6 as viewed from the rear. A brace 5 is attached at one end to the base 3 and at another end to the backside 10, of one of the panels 1. The sign 6 is attached to outdoor menu 2 by a clamp 11 which does not penetrate the outer skin of the menu 2.

I claim:

1. A sign comprising:
(a) a panel;
(b) the panel having a support surface;
(c) a base;
(d) a display;
(e) the display having a mounting surface;
(f) the display having an image surface;
(g) the mounting surface being attached to the support surface;
(h) the base removably connecting the panel to business equipment.

2. The sign of claim 1 wherein the base is removably connecting the panel to the business equipment with a clamp.

3. The sign of claim 1 wherein the business equipment is located near a traffic corridor.

4. The sign of claim 1 further comprising:
(a) the business equipment being located near a traffic corridor;
(b) the base configured to position the panel with the support surface facing the traffic;
(c) the image surface displaying markings thereon for viewing from the traffic corridor.

5. The sign of claim 1 further comprising:
(a) a brace to limit relative motion between the panel and base;
(b) the brace having a first end and a second end;
(c) the first end being attached to the panel;
(d) the second end being attached to the base.

6. The sign of claim 1 wherein:
(a) the support surface is ferromagnetic;
(b) the mounting surface is magnetically attached to the support surface thereby making the display easily attachable and detachable from the support surface.

7. The sign of claim 1 wherein the clamp does not penetrate the business equipment preventing destruction of the business equipment thereby.

8. The sign of claim 1 wherein there is a plurality of panels.

9. The sign of claim 1 further comprising:
(a) a brace to limit relative motion between the panel and base;
(b) there being a plurality of panels;
(c) the brace having a first end and a second end;
(d) the first end being attached to at least one panel;
(e) the second end being attached to the base.

10. The sign of claim 1 wherein the support surface is non-rectangular.

11. A sign comprising:
(a) a panel having a base and a support surface;
(b) a display having a mounting surface and an image surface; and
(c) the mounting surface connecting to the support surface so that the display conforms to the support surface.

12. The sign of claim 11 wherein the mounting surface is a flexible mounting surface.

13. The sign of claim 12 wherein the support surface is non-planar.

14. The sign of claim 12 wherein the mounting surface is a magnetic mounting surface.

15. The sign of claim 12 wherein the display diverges from the support surface.

16. The sign of claim 11 wherein the panel comprises a plurality of support surfaces.

17. The sign of claim 16 wherein the plurality includes one or more non-planar support surfaces.

18. The sign of claim 16 wherein the plurality of support surfaces presents an interrupted combined support surface.

19. The sign of claim 18 wherein the mounting surface is flexible and magnetic, and wherein the mounting surface conforms to the interrupted combined support surface.

20. A sign comprising:
(a) a plurality of panels;
(b) a display;
(c) a base;
(d) a brace to limit relative motion between the panel and base;
(e) the plurality of panels having a support surface;
(f) the support surface being ferromagnetic;
(g) the support surface being non-rectangular;
(h) the display having a mounting surface;
(i) the display having an image surface;
(j) the mounting surface being magnetically attached to the support surface thereby making the display easily attachable and detachable from the support surface;
(k) the base having a clamp;
(l) the base clamping the plurality of panels to business equipment without penetrating the business equipment and preventing destruction of the business equipment thereby;
(m) the business equipment being located near a traffic corridor;
(n) the base being configured to position the plurality of panels with the support surface facing the traffic;
(o) the image surface displaying markings thereon for viewing from the traffic corridor;
(p) the brace having a first end;
(q) the brace having a second end;
(r) the first end being attached to the plurality of panels;
(s) the second end being attached to the base;
(t) the business equipment being an outdoor menu.
